(19) United States
(12) Patent Application Publication
(10) Pub. No.: US 2018/0014617 A1
(43) Pub. Date: Jan. 18, 2018

(54) METHOD AND APPARATUS FOR LIGHTING AN INSULATED CONTAINER

(71) Applicant: Brightz, ltd., Ottawa Lake, MI (US)

(72) Inventors: Martha FINCH, Ottawa Lake, MI (US); Eric FINCH, Ottawa Lake, MI (US)

(73) Assignee: Brightz, ltd., Ottawa Lake, MI (US)

(21) Appl. No.: 15/345,107

(22) Filed: Nov. 7, 2016

Related U.S. Application Data
(60) Provisional application No. 62/361,250, filed on Jul. 12, 2016.

(51) Int. Cl. A45C 15/06; F21V 23/04; A45C 11/20; F21V 23/00; B65D 81/38; B65D 43/16; F21V 31/00; F21V 23/02

(52) U.S. Cl. CPC A45C 15/06; F21V 31/00; F21V 23/0442; F21V 23/023; F21V 23/001; B65D 81/3813; B65D 43/16; A45C 11/20; F21Y 2115/10

(57) ABSTRACT

Systems are provided herein including an insulated container and an illumination device. The insulated container has a lid and a water-resistant lower portion with an exterior surface and an interior cavity. The illumination device includes a power source that attaches to the exterior surface of the insulated container, a conductive cable extending into the interior cavity and between an edge portion of the lower portion and the lid, and a plurality of light sources. The conductive cable and plurality of light sources may be waterproof while the power source is not waterproof. The illumination device may also include a pressure switch disposed between the edge portion and lid so that when the lid closes the electrical connection between the power source and light sources is interrupted. The power source may be made removable from the exterior surface so that the illumination device may be transferred to other insulated containers.

### CROSS REFERENCE TO RELATED APPLICATIONS

This non-provisional application claims the benefit of U.S. Provisional Application 62/251,397, filed on Nov. 5, 2015, and also claims the benefit of U.S. Provisional Application 62/361,250, filed on Jul. 12, 2016, the disclosures of which are incorporated herein by reference.

### BACKGROUND AND SUMMARY

The present invention relates generally to systems and apparatuses of portable illumination for insulated containers.

Presently, containers comprising an insulating material are used to keep food and drinks cold at social gatherings. These containers are filled with beverages and ice, and may have a lid which can close and form a seal around the contents. The lid and seal keep the contents cold for a period of time by preventing warmer air entering the container.

Some insulated containers may include integral illumination sources disposed within the walls and structure of the containers. These containers include sidewalls which enable interior illumination while retaining an insulating function. Such container structures may substantially increase manufacturing costs and consequently may be expensive to purchase. Further, illumination sources integrated into a container cannot be transferred to another container.

However, even though portable illumination devices may be placed in the interior of an insulated container, portable illumination devices present numerous problems. These devices are generally small and rigid. Additionally, portable illumination devices require a waterproof power source, increasing per-unit cost. These prior art portable illumination devices generally emit light from a localized area and do not emit light from different points within the container. If a portable illumination device is attached via adhesive, the adhesive must function in a freezing aquatic environment and may also need to be waterproof or water resistant to maintain adhesion to a cooler wall, also increasing costs.

Some illumination devices may be mounted in limited locations on the underside of the container's lid or near a hinge. The mounting methods involve adhering or fastening the entire device directly on the interior of the container. Removing the devices at a later date requires ripping off the adhesive or unfastening the unit, which may leave holes in the insulating structure.

Some illumination devices may also have a motion or tilt sensor to switch the lights off when the insulated container is closed. Generally, these kinds of sensors fail to adequately or accurately determine when the container is in use. For example, a tilt sensor may continuously be in the “on” state if the container is positioned on a sloped surface. If the device uses a motion sensor, a container which has a lid in the open position will not be continuously lit and the device would have to be shaken after standing still for a period of time in order to provide the illumination. Thus, there is a need for a system for illuminating an insulated container that provides effective illumination of the container interior that overcomes the limitations of existing illumination systems.

Presently disclosed, in one aspect, is a system comprising an insulated container and an illumination device, the insulated container comprising a lid and a water-resistant lower portion, the water-resistant lower portion including an at least one side wall, a bottom wall, a core portion, an edge portion, an exterior surface, and an interior cavity capable of retaining water; and the illumination device comprising: a power source attached to the exterior surface of the insulated container; a conductive cable extending from the power source into the interior cavity of the insulated container without the conductive cable passing through the core portion of the insulated container, wherein the conductive cable is waterproof and wherein a portion of the conductive cable is disposed between the edge portion and the lid of the insulated container; and a plurality of light sources disposed along the conductive cable, each light source being waterproof.

Also disclosed, in another aspect, is a lid and a water-resistant lower portion, the water-resistant lower portion including an at least one side wall, a bottom wall, a core portion, an edge portion, an exterior surface, and an interior cavity capable of retaining water; a power source attached to the exterior surface of the insulated container; a conductive cable extending from the power source into the interior cavity without the conductive cable passing through the core portion of the insulated container, wherein the conductive cable is waterproof and wherein a portion of the conductive cable is disposed between the edge portion and the lid; and a plurality of light sources disposed along the conductive cable, each light source being waterproof.

### BRIEF DESCRIPTION OF THE DRAWINGS

Various embodiments of the invention are illustrated and explained with reference to the accompanying drawings in which:

FIG. 1 depicts an isometric perspective view of a system including an insulated container and an illumination device, in accordance with one or more aspects of the present invention;

FIG. 2 depicts a cross-sectional top-down view of the insulated container and illumination device of FIG. 1, in accordance with one or more aspects of the present invention;

FIG. 3 depicts an exterior view of the insulated container of FIG. 1, in accordance with one or more aspects of the present invention;

FIG. 4 depicts a side cross-sectional view of the insulated container and illumination device of FIG. 1, in accordance with one or more aspects of the present invention;

FIG. 5 depicts a close-up view of a portion of the insulated container and power source of FIG. 1, in accordance with one or more aspects of the present invention; and,

FIG. 6 depicts a close-up view of the power source of FIG. 5, in accordance with one or more aspects of the present invention.

### DETAILED DESCRIPTION

With reference to the drawings, like reference numerals designate identical or corresponding parts throughout the several views. However, the inclusion of like elements in different views does not mean a given embodiment necessarily includes such elements or that all embodiments of the invention include such elements.

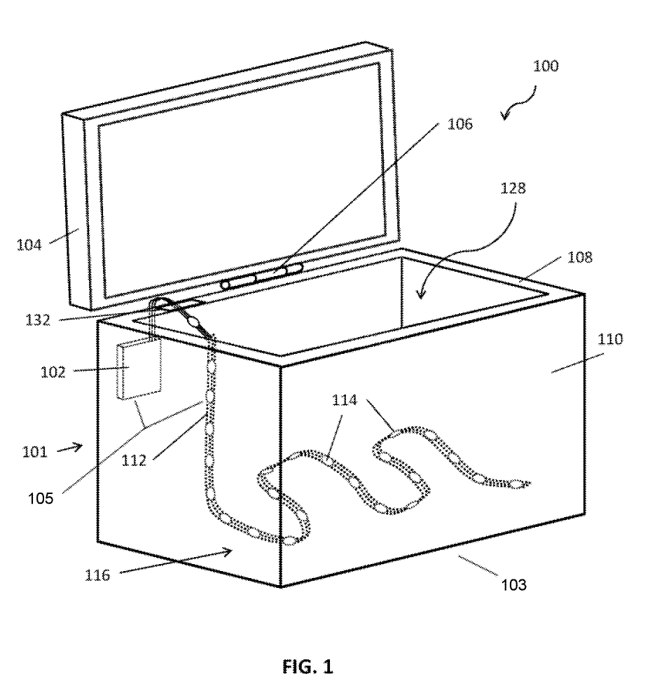

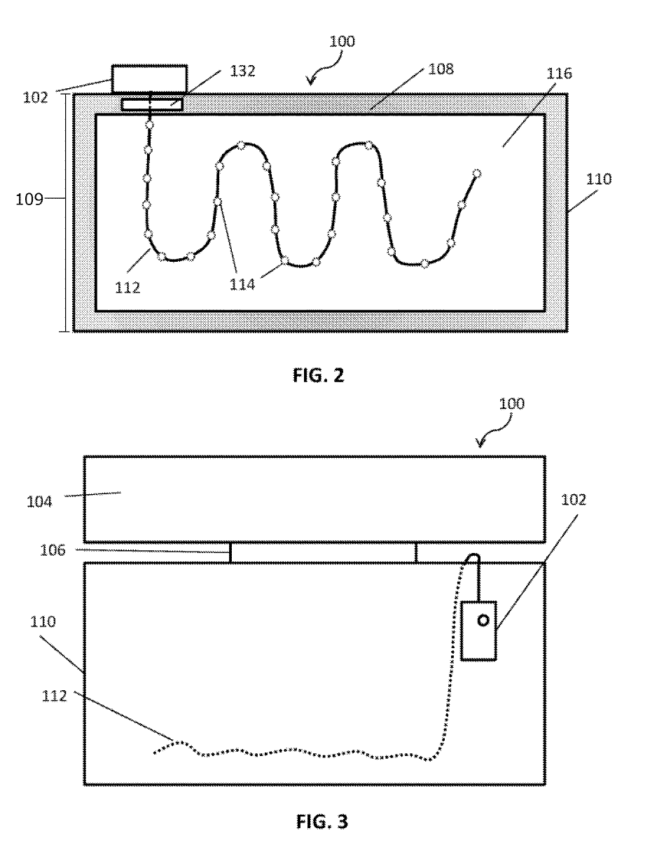

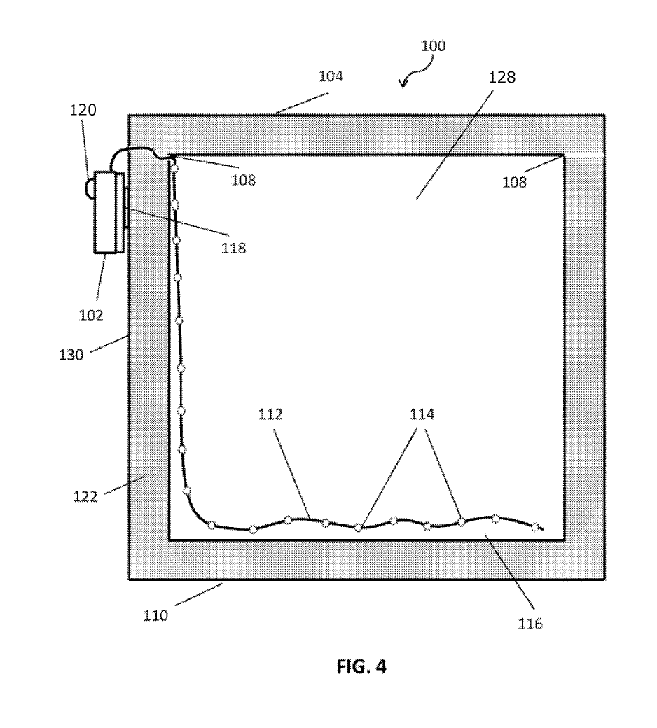

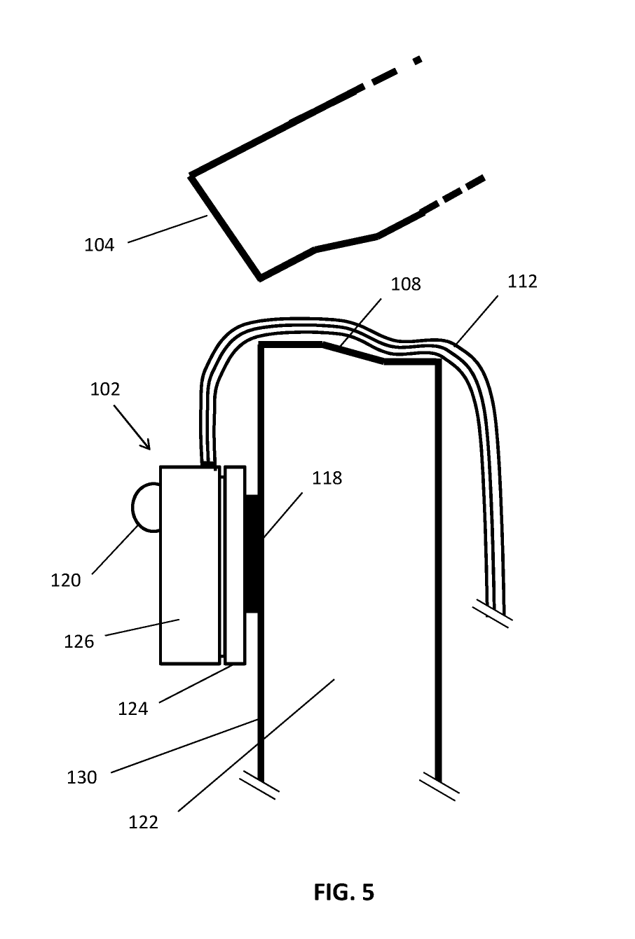

FIG. 1 depicts an isometric perspective view of a system 100 including an insulated container 103 and an illumination device 105. The insulated container 103 may include a lid 104 and a lower portion 101. In alternative embodiments, insulated container may only include a lower portion 101 and may not have a lid 104 attached. Lower portion 101 is water-resistant and includes an exterior surface 110, an at least one sidewall 109 (see FIG. 2), a bottom wall 116, and a core portion 122 (as shown in FIG. 4). Lower portion 101 also includes an edge portion 108 and an interior cavity 128. The interior cavity 128 may be designed to retain water and/or ice. The core portion 122 may generally include insulating material and may be disposed between the exterior surface and an interior surface of the container (as depicted, for example, in FIGS. 4-5). Lid 104 may be attached to lower portion 101 by one or more hinges 106. The illumination device 105 may include a power source 102 attached to the exterior surface 110 of the insulated container 103, and a conductive cable 112 extending from power source 102 into interior cavity 128 of the insulated container. As FIG. 1 shows, conductive cable 112 does not pass through the core portion of the insulated container, but passes between edge portion 108 and lid 104. Conductive cable 112 may be disposed between edge portion 108 and lid 104 so as not to interfere with one or more hinges 106 and without significantly interfering with lid 104 making a tight closing seal with edge portion 108. As conductive cable 112 extends into interior cavity 128, and interior cavity is designed to retain water, conductive cable 112 may be a waterproof conductive cable. Conductive cable 112 has a plurality of light sources 114 disposed along a length of the conductive cable 112.

FIG. 1 also shows illumination device 105 including a pressure switch 132. Pressure switch 132 may be placed on edge portion 108 so that when lid 104 is closed pressure switch 132 interrupts an electrical connection between power source 102 and the plurality of light sources 114. When the lid 104 is opened, pressure switch 132 no longer interrupts the electrical connection and power may flow to the plurality of light sources 114. It may be understood that in alternative embodiments, for example embodiments in which insulated container 103 does not have a lid 104 attached by a hinge 106, the illumination device 105 may not have a pressure switch 132 and may be turned on or off manually, as described further below.

FIG. 2 shows the system 100 of FIG. 1 from a top-down perspective (omitting lid 104 for convenience). The conductive cable 112 of the illumination device may generally be disposed over the bottom wall 116 of the insulated container within interior cavity 128. The illumination device 105 includes a plurality of light sources 114 disposed along conductive cable 112, each light source being waterproof so that water or ice retained in interior cavity 128 does not damage or interfere with operation of the plurality of light sources 114. Conductive cable 112 may be flexible so that the cable 112 and plurality of light sources 114 may be arranged in any way desired within interior cavity 128. In one example embodiment, the plurality of light sources 114 may be evenly spaced or evenly distributed over a length of conductive cable 112, and may be evenly spaced along the entire length of conductive cable 112. The plurality of light sources 114, in one embodiment, may include a plurality of LED (light emitting diode) light sources. LED light sources generally require a small amount of electrical power to operate compared to other types of light sources, and produce minimal heat. Other light sources tend to undesirably heat the interior cavity 128 of the insulated container.

FIG. 3 is another exterior view of the system 100 of FIG. 1, showing power source 102 attached to an exterior surface 110 of the insulated container with lid 104 of the insulated container opened and conductive cable 112 extending into the interior cavity of the insulated container. Although conductive cable 112 may ideally be waterproof, power source 102 does not need to be made waterproof as it may attach to exterior surface 110 of the insulated container, and thus will not contact water or ice retained in interior cavity 128.

Positioning or attaching the power source 102 on the exterior surface 110 of the insulated container solves a number of issues while providing a superior and more easily manufactured product. Since power source 102 is not waterproof, many components may be eliminated, such as a gasket and gasket material and the like. An adhesive used to attach the power source or conductive cable does not need to be engineered to function while submerged in water for extended periods of time. The overall cost of the products and system may be significantly reduced, and the illumination device may be transferred from one container to another.

FIG. 4 depicts a side cross-sectional view of a portion of the system 100 of FIG. 1, with lid 104 in a closed position to keep interior cavity 128 sealed from exterior environments. Conductive cable 112 and plurality of illumination sources 114 extend from power source 102 into interior cavity 128 by passing between edge portion 108 and lid 104 without significantly affecting the insulating properties of lid 104 or core region 122. As FIG. 4 shows, power source 102 may ideally attach to a back portion 130 of exterior surface 110 so that conductive cable 112 may pass over edge portion 108 on the same side of the insulated container as the hinge 106 (not shown in FIG. 4). To ensure that conductive cable 112 does not significantly interfere with the lid 104 making a tight closing seal with edge portion 108, in exemplary embodiments conductive cable 112 may have a thickness of 5 mm or less. The conductive cable 112 may be made waterproof with a material that does not significantly increase the thickness of conductive cable 112 but that also protects conductive cable 112 from being damaged when lid 104 is opened and closed repeatedly.

FIG. 5 Illustrates power source 102. Power source 102 may be, in one embodiment, a battery pack, and may include a top portion 126 removably attached to a bottom portion 124, where the bottom portion 124 is attached to the exterior surface 110 of the insulated container. Top portion 126 may be removable from bottom portion 124 to allow for battery replacement without removing the entire power source 102 from the insulated container. In one example, bottom portion 124 may be attached to exterior surface 110 by a hook and loop system 118, such as a Velcro system. In another example, bottom portion 124 may be attached to exterior surface 110 by at least one threaded fastener, such as a screw. In yet another example, bottom portion 124 may be attached to exterior surface 110 by an adhesive. Other means of attaching bottom portion 124 to exterior surface 110 are contemplated within the scope of this disclosure. Those with skill in the art will note that power source 102 need not be a battery pack as described above. In alternative embodiments, power source 102 may be, for example, a solar power source including one or more solar panels capable of delivering power through conductive cable 112 to the plurality of light sources 114 (not depicted in FIG. 5).

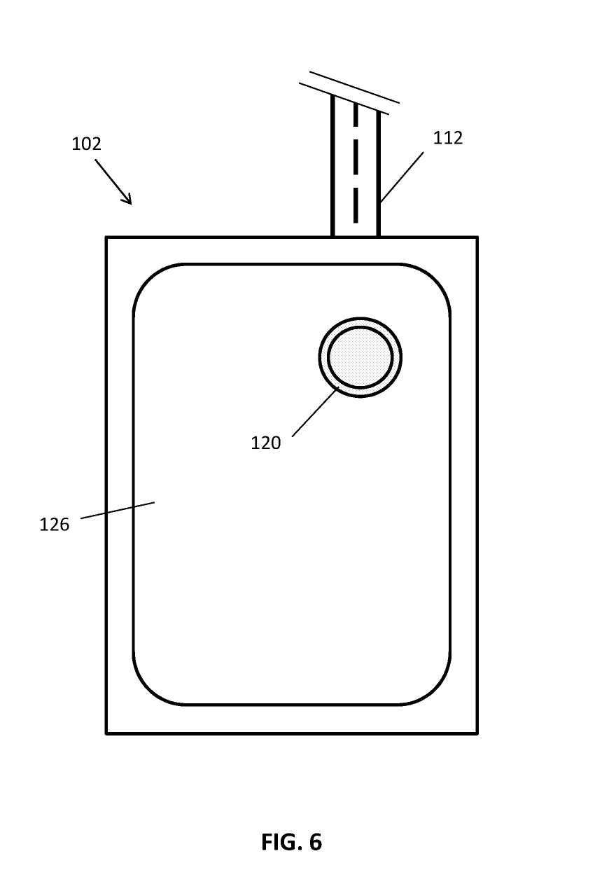

FIG. 6 depicts another close-up view of power source 102 with conductive cable 112 extending from power source 102. Power source 102 may, in exemplary embodiments, include a power switch or button 120 that may be used to manually switch power source 102 on or off. When switched off, the plurality of light sources 114 (not shown in FIG. 6) remain off whether lid 104 of the insulated container is closed or open. When switched on, the plurality of light sources 114 are turned on. If the illumination device includes a pressure switch 132, such as depicted in FIG. 1, then the pressure switch 132 operates to turn the plurality of light sources 114 on and off when the lid is opened and closed so long as power switch or button 120 is switched on.

In the specification and claims, reference will be made to a number of terms that have the following meanings. The singular forms “a,” “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated a myriad of additional or alternate examples of varying scope could have been presented, but have been omitted for purposes of brevity.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

This written description uses examples to disclose the invention, including the best mode, and also to enable one of ordinary skill in the art to practice the invention, including making and using devices or systems and performing incorporated methods. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A system comprising:
an insulated container comprising a lid and a water-resistant lower portion, the water-resistant lower portion including an at least one side wall, a bottom wall, a core portion, an edge portion, an exterior surface, and an interior cavity capable of retaining water;
an illumination device comprising:
a power source attached to the exterior surface of the insulated container;
a conductive cable extending from the power source into the interior cavity of the insulated container without the conductive cable passing through the core portion of the insulated container, wherein the conductive cable is waterproof and wherein a portion of the conductive cable is disposed between the edge portion and the lid of the insulated container; and
a plurality of light sources disposed along the conductive cable, each light source being waterproof.

2. The system of claim 1, where the power source is not waterproof.

3. The system of claim 2, where the conductive cable includes a pressure switch placed on the edge portion, the pressure switch interrupting an electrical connection to the plurality of light sources when the lid is placed in a closed position.

4. The system of claim 2, where the conductive cable has a thickness of less than or equal to 5 mm.

5. The system of claim 2, where the light sources are spaced evenly along the entire length of the conductive cable.

6. The system of claim 2, where the power source is a battery pack comprising a top portion removably attached to a bottom portion, where the bottom portion is attached to the exterior surface of the insulated container.

7. The insulated container of claim 6, where the bottom portion is attached to the exterior surface by a hook and loop system.

8. The insulated container of claim 6 where the bottom portion is attached to the exterior surface by at least one threaded fastener.

9. The insulated container of claim 6, where the bottom portion is attached to the exterior surface by an adhesive capable of functioning in moist environments.

10. An insulated container, comprising:
a lid and a water-resistant lower portion, the water-resistant lower portion including an at least one side wall, a bottom wall, a core portion, an edge portion, an exterior surface, and an interior cavity capable of retaining water;
a power source attached to the exterior surface of the insulated container;
a conductive cable extending from the power source into the interior cavity without the conductive cable passing through the core portion of the insulated container, wherein the conductive cable is waterproof and wherein a portion of the conductive cable is disposed between the edge portion and the lid; and
a plurality of light sources disposed along the conductive cable, each light source being waterproof.

11. The insulated container of claim 10, where the power source is not waterproof.

12. The insulated container of claim 11, where the conductive cable includes a pressure switch placed on the edge portion, the pressure switch interrupting an electrical connection to the plurality of light sources when the lid is placed in a closed position.

13. The insulated container of claim 11 where the conductive cable has a thickness of less than or equal to 5 mm.

14. The insulated container of claim 11, where the light sources are spaced evenly along the entire length of the conductive cable.

15. The insulated container of claim 11, where the power source is a battery pack comprising a top portion removably attached to a bottom portion, where the bottom portion is attached to the at least one side wall.

16. The insulated container of claim 11, where the bottom portion is attached to the at least one side wall by a hook and loop system.

17. The insulated container of claim 11, where the bottom portion is attached to the at least one side wall by at least one threaded fastener.

18. The insulated container of claim 11, where the bottom portion is attached to the at least one side wall by an adhesive capable of functioning in moist environments.
